(19) United States
(12) Patent Application Publication
(10) Pub. No.: US 2010/0103645 A1
(43) Pub. Date: Apr. 29, 2010

(54) CENTRIFUGAL PRECIPITATING METHOD AND LIGHT EMITTING DIODE AND APPARATUS USING THE SAME

(75) Inventors: Yao-Ching Su, Taoyuan City (TW); Jia-Ling Teng, Guanxi Town (TW); Ming-Lung Lu, Xinpu Town (TW)

Correspondence Address: RABIN & Berdo, PC, 1101 14TH STREET, NW, SUITE 500, WASHINGTON, DC, 20005, US

(73) Assignee: Wellypower Optronics Corp, Hsinchu County (TW)

(21) Appl. No.: 12/579,814

(22) Filed: Oct. 15, 2009

(30) Foreign Application Priority Data
Oct. 29, 2008 (TW) 097141686

(51) Int. Cl. F21V 21/30; F21V 19/00

(52) U.S. Cl. 362/35; 362/382

(57) ABSTRACT

A centrifugal precipitating method is provided. The method includes the following steps. A lighting structure is provided. The lighting structure includes a frame, a chip and a colloid. The frame has a recess. The chip is disposed on a bottom surface of the recess. The colloid includes a glue and several fluorescent particles. The glue is filled in the recess and covers the chip. The fluorescent particles are distributed in the glue. Then, the lighting structure is rotated to move the fluorescent particles toward the bottom surface of the recess.

This application claims the benefit of Taiwan application Serial No. 97141686, filed Oct. 29, 2008, the subject matter of which is incorporated herein by reference.

### BACKGROUND OF THE INVENTION

1. Field of the Invention

The invention relates in general to a precipitating method and a light emitting diode and an apparatus using the same, and more particularly to a centrifugal precipitating method and a light emitting diode and an apparatus using the same.

2. Description of the Related Art

At present, the light emitting diode (LED) has a wide range of application including sign board, traffic signs, or the backlight source of a display device. Generally speaking, the LED manufacturing process is basically divided into the steps of chip bonding, wire bonding, adhesive dispensing, and packaging. The chip bonding step is for fixing the chip in several bowl-shaped recesses of a frame. The wire bonding step is for soldering wire onto the chip for being electrically connected to the chip. The adhesive dispensing step is for injecting colloid into the bowl-shaped recess for covering the chip. The packaging step is for dividing and packaging the LEDs accomplished on the frame.

The adhesive dispensing step is further divided into several sub-steps, such as the steps of mixing glue and fluorescent powder to obtain a colloid, deaeration, injecting the colloid into bowl-shaped recess, deaeration again, precipitating and baking the fluorescent powder. The sub-step of precipitating the fluorescent powder is one of the important factors affecting the light emitting effect of the LED and the uniformity of light and color distribution. Currently, there are two methods of precipitating the fluorescent powder, namely, heating and depositing the colloid. The two methods are disclosed below.

In the method of heating the colloid, the glue becomes thinner after being heated. As the specific gravity of the fluorescent powder is relatively greater than that of the glue, the fluorescent powder suspended in the colloid will be deposited at the bottom. Thus, the fluorescent powder will be precipitated on the bottom of the bowl-shaped recess due to the difference between the specific gravities of the fluorescent powder and the glue. However, not all types of glue can have a specific gravity which is significantly different from that of the fluorescent powder when being heated. As such, it is possible that the fluorescent powder can not be precipitated on the bottom of the bowl-shaped recess successfully.

According to the deposition method, the fluorescent powder is gradually precipitated on the bottom of the recess by the gravity. However, whether the fluorescent powder is capable of being precipitated on the bottom of the recess is determined according to the time period for deposition, the concentration of glue, and the specific gravity of the fluorescent powder. Thus, the time cost for manufacturing LED is increased, and the overall productivity of LED is decreased accordingly.

Thus, under the requirement of high efficiency, it is an imminent issue for the manufacturers to provide a method and apparatus capable of precipitating the fluorescent powder on the bottom of the recess and whereby increasing both of the light emitting effect and quality of LED.

### SUMMARY OF THE INVENTION

The invention is directed to a centrifugal precipitating method and a light emitting diode (LED) and an apparatus using the same. A lighting structure is rotated so as to provide a centrifugal force thereto, and the fluorescent particles of the colloid are moved toward a bottom surface of the recess, whereby achieve the effect of efficiently precipitating the fluorescent particles. In an embodiment, the particle diameter of the fluorescent particles is preferably but non-limitedly less than 30 μm. According to the disclosure, the surface of the colloid in the lighting structure becomes even while the bubbles that are formed by the air in the colloid are also discharged. Thus, the light emitting effect, conformity rate and quality of the LED are correspondingly increased.

According to a first aspect of the present invention, a centrifugal precipitating method is provided. The method includes the following steps. A lighting structure is provided. The lighting structure includes a frame, a chip and a colloid. The frame has a recess. The chip is disposed on a bottom surface of the recess. The colloid includes a glue and several fluorescent particles. The glue is filled in the recess and covers the chip. The fluorescent particles are distributed in the glue. Then, the lighting structure is rotated to move the fluorescent particles toward the bottom surface of the recess.

According to a second aspect of the present invention, an LED including a frame, a chip and a colloid is provided. The frame has a recess. The chip is disposed on a bottom surface of the recess. The colloid includes a glue and several fluorescent particles. The glue is filled in the recess and covers the chip. The fluorescent particles are distributed in the glue by way of covering the bottom surface of the recess and the light output surface of the chip.

According to a third aspect of the present invention, a centrifugal precipitating apparatus used in a lighting structure is provided. The lighting structure includes a frame, a chip and a colloid. The frame has a recess. The chip is disposed on a bottom surface of the recess. The colloid includes a glue and several fluorescent particles. The glue is filled in the recess and covers the chip. The fluorescent particles are distributed in the glue. The centrifugal precipitating apparatus includes a rotation apparatus and a fixing mechanism. The rotation apparatus rotates the lighting structure, so that the fluorescent particles are moved toward the bottom surface of the recess. The fixing mechanism is disposed on the rotation apparatus for fixing the lighting structure.

The invention will become apparent from the following detailed description of the preferred but non-limiting embodiments. The following description is made with reference to the accompanying drawings.

### BRIEF DESCRIPTION OF THE DRAWINGS

FIG. 1A is a schematic diagram of showing an example of a lighting structure;

FIG. 1B is a cross-sectional view showing a pre-precipitated LED along the cross-sectional line 1B-1B of FIG. 1A;

FIG. 2 is a schematic diagram showing the lighting structure of FIG. 1A disposed on the centrifugal precipitating apparatus according to a first embodiment of the invention;

FIG. 3 shows a flowchart of a centrifugal precipitating method according to a first embodiment of the invention;

FIG. 4 is a cross-sectional view showing an example of an LED executing the centrifugal precipitating method of FIG. 3;

FIG. 5A shows a CIE-X-axial box plot of a pre-precipitated LED and an LED using the centrifugal precipitating method of the present embodiment of the invention;

FIG. 5B shows a CIE-Y-axial box plot of a pre-precipitated LED and an LED using the centrifugal precipitating method of the present embodiment of the invention;

FIG. 6A shows a CIE-X-axial box plot of an anti-precipitated LED and an LED using the centrifugal precipitating method of the present embodiment of the invention;

FIG. 6B shows a CIE-Y-axial box plot of an anti-precipitated LED and an LED using the centrifugal precipitating method of the present embodiment of the invention;

FIG. 7 is a schematic diagram showing the lighting structure of FIG. 1A disposed on the centrifugal precipitating apparatus according to a second embodiment of the invention;

FIG. 8 is a cross-sectional view of along the cross-sectional line 8-8′ of FIG. 7;

FIG. 9 shows a flowchart of a centrifugal precipitating method according to a second embodiment of the invention;

### DETAILED DESCRIPTION OF THE INVENTION

The embodiment of this invention provides a centrifugal precipitating method. The method includes the following steps. Firstly, a lighting structure is provided. The lighting structure includes a frame, a chip and a colloid. The frame has a recess. The chip is disposed on a bottom surface of the recess. The colloid includes a glue and several fluorescent particles. The glue is filled in the recess and covers the chip. The fluorescent particles are distributed in the glue. Next, the lighting structure is rotated to move the fluorescent particles toward the bottom surface of the recess.

Two embodiments are disclosed below for elaborating a centrifugal precipitating method and a light emitting diode (LED) and apparatus using the same. However, anyone who is skilled in the art of the invention will understand that the drawings and disclosure are for elaboration only, and are intended to limit the invention.

### First Embodiment

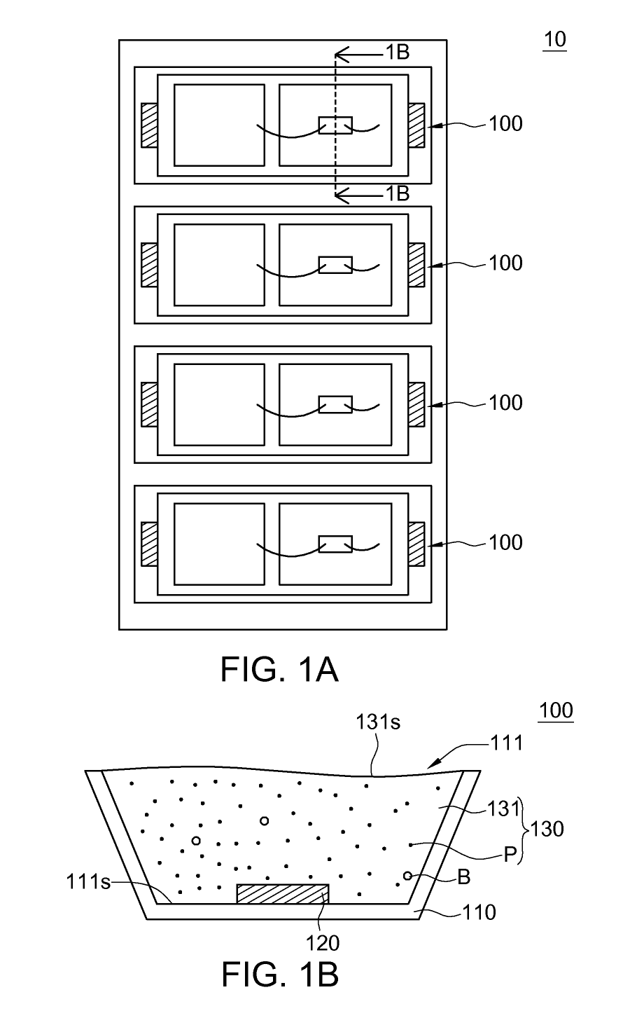

The present embodiment of the invention is exemplified by performing the centrifugal precipitating method on the lighting structure 10 in FIG. 1A for illustration. FIG. 1A is a schematic diagram showing an example of a lighting structure. The lighting structure 10 includes a number of pre-precipitated LEDs 100 which are not precipitated and divided yet.

FIG. 1B is a cross-sectional view showing a pre-precipitated LED along the cross-sectional line 1B-1B of FIG. 1A. The pre-precipitated LED 100 includes a frame 110, a chip 120 and a colloid 130. The frame 110 has a recess 111 of bowl-shaped for example. The chip 120 is disposed on a bottom surface 111s of the recess 111 for emitting a blue light for example. The colloid 130 includes two types of glue 131 (such as a mixture of A-type of glue and B-type of glue) and several yellowish fluorescent particles P. The glue 131 is filled in the recess 111 and covers the chip 120. The fluorescent particles P are distributed in the glue 131. It is exemplified here that the colloid 130 has two types of glue 131 and several yellowish fluorescent particles P, but the colloid 130 can also have several different fluorescent particles and one glue which is a mixture of different types of glue.

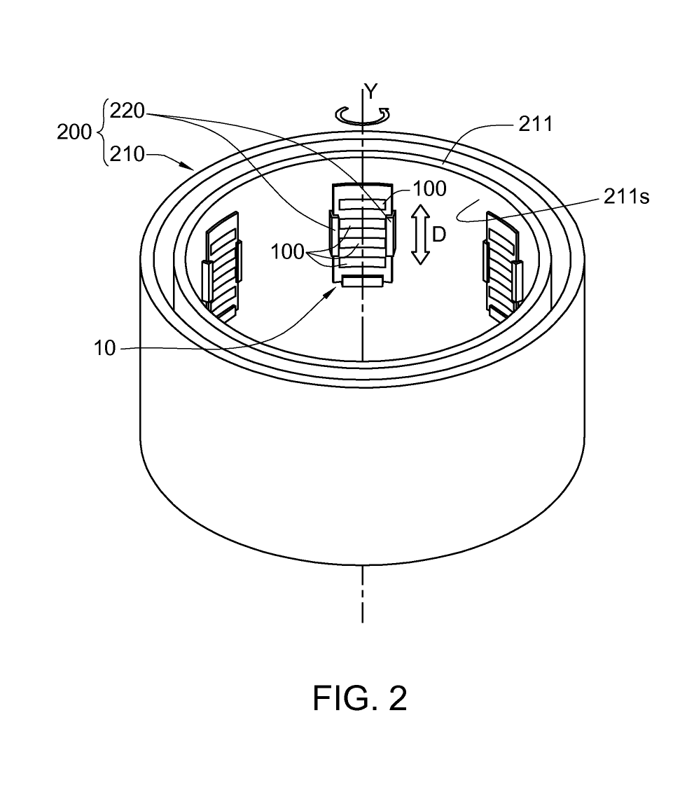

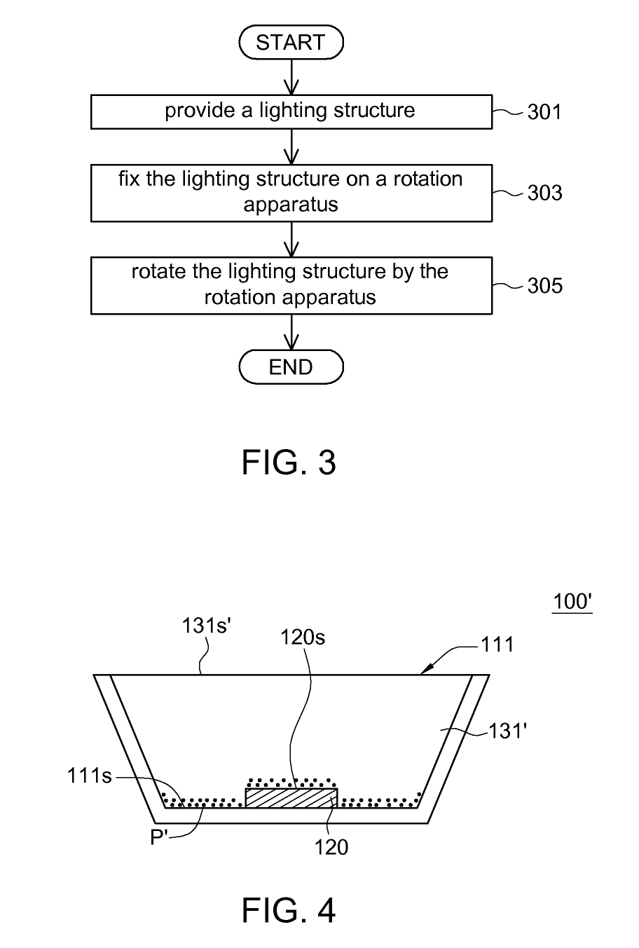

The centrifugal precipitating apparatus 200 in FIG. 2 will be taken as an example to execute the centrifugal precipitating method and steps of FIG. 3, so that the fluorescent particles P of several pre-precipitated LEDs 100 of the lighting structure 10 in FIG. 1A is precipitated. However, anyone who is skilled in the art of the invention will understand that the centrifugal precipitating method of the invention is not limited to the procedures and sequences of the flowchart as shown in FIG. 3, or is not limited to be applied in the centrifugal precipitating apparatus 200 as shown in FIG. 2. Also, the centrifugal precipitating method is not limited to using the lighting structure 10 of FIG. 1A. For example, the centrifugal precipitating method can further be applied to a pre-precipitated LED having several chips or different types of chips.

The disposition and functions of the circuit elements in the centrifugal precipitating apparatus 200 are illustrated as follows. The centrifugal precipitating apparatus 200 includes a rotation apparatus 210 and a fixing mechanism 220. The rotation apparatus 210 has an accommodation recess 211 for rotation. In the present embodiment of the invention, the fixing mechanism 220, for example, is implemented by several engaging members, which are located on an inner wall 211s of the accommodation recess 211 for fixing the lighting structure by way of engaging. The structure and type of the fixing mechanism 220 are not limited to the above exemplification, and any mechanisms capable of fixing the lighting structure on the inner wall 211s of the accommodation recess 211 can also be used in the present embodiment of the invention.

The centrifugal precipitating method of FIG. 3 is further used for elaboration. Firstly, the method begins at step 301, a lighting structure 10 of FIG. 1A is provided. Preferably, the particle diameter of the fluorescent particles P (as indicated in FIG. 1B) of the lighting structure 10 is smaller than 30 μm.

Next, the method proceeds to step 303, the lighting structure 10 is fixed on an inner wall 211s of the accommodation recess 211 of the rotation apparatus 210 by the fixing mechanism 220. Preferably, the colloid 130 of the lighting structure 10 is disposed to face the rotation axis Y of the accommodation recess 211. In general, when the colloid 130 of the lighting structure 10 is disposed to face the rotation axis Y of the accommodation recess 211 (i.e., the colloid 130 is vertically disposed on the lighting structure 10), the colloid 130 may disperse outside the recess 111 due to gravity. Thus, the present embodiment of the invention may adjust the dimensions of the recess 111 and the pre-precipitated LED 100 so as to avoid the colloid 130 dispersing outside the recess 111. In the present embodiment of the invention, the length and width of the recess 111 are adjusted to be smaller than 50 mm, and the length and width of the pre-precipitated LED 100 are adjusted to be smaller than 7 mm. It is only an exemplification of the present embodiment of the invention to avoid the colloid 130 dispersing outside the recess 111 by adjusting the dimensions of the recess 111 and the pre-precipitated LED 100. In other exemplification, it is also practicable to avoid the colloid 130 dispersing outside the recess 111 by driving the pre-precipitated LED 100 to swing or by appropriately selecting the glue 131 of the colloid 130 and its co-operated mechanism, which can be referred to the second embodiment for further description. Besides, because the pre-precipitated LEDs 100 of the lighting structure 10 are arranged along a direction D, the lighting structure 10 is preferably fixed on the inner wall 211s with the direction D being parallel to the rotation axis Y of the accommodation recess 211, whereby the centrifugal force can be evenly provided to the pre-precipitated LEDs 100.

Then, the method proceeds to step 305, the lighting structure 10 is driven to rotate by the accommodation recess 211 of the rotation apparatus 210 which is rotated. That is, when the accommodation recess 211 is driven at a rotation speed of 3000 rpm (revolutions per minute) for example, the accommodation recess 211 being rotated drives the lighting structure 10 to rotate through the fixing mechanism 220. Because the frame 110 of the lighting structure 10 is a flexible structure, the lighting structure 10 being driven turns into a condition as being attached on the inner wall 211s of the accommodation recess 211 due to the centrifugal force. Besides, as the lighting structure 10 is fixed with its colloid facing the rotation axis Y of the accommodation recess 211, the fluorescent particles P of the colloid 130 of each pre-precipitated LED 100 are moved toward the bottom surface 111s of the recess 111 by the centrifugal force generated during rotation, whereby the fluorescent particles P of the colloid 130 are distributed in a manner illustrated in FIG. 4.

As indicated in FIG. 4, the fluorescent particles P′ of the LED 100′ cover the bottom surface 111s of the recess 111 and the light output surface 120s of the chip 120. As indicated in FIG. 1B, during the course of flowing into the recess 111, the bubbles B are usually generated or an uneven surface 131s is usually formed. As a result, the light emitted by the chip 120 will be deflected or scattered when passing through the bubbles B or the uneven surface 131s. As compared with the above conduction, this embodiment shows that after applying the centrifugal precipitating method, the surface 131s′ of the glue 131 in FIG. 4 can be regarded as having even distribution through the centrifugal force, and the bubbles stored in the glue 131′ can also be discharged, whereby improve the light emitting efficiency of the LED 100′.

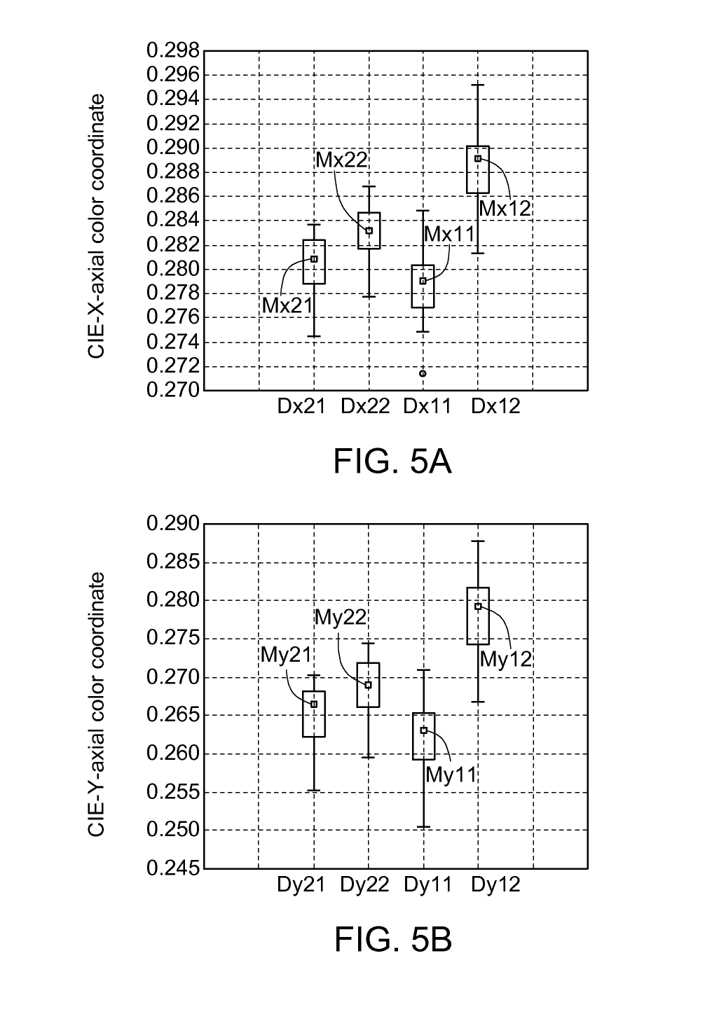

In addiction, when the LED is disposed on the backlight module as a light source, the axial light intensity of the LED is preferably close to the luminous flux measured by an integrating sphere when the LED is disposed on the backlight module, so that the LED has an even light color distribution when being disposed on the backlight module. FIG. 5A shows a CIE-X-axial box plot of a pre-precipitated LED and an LED using the centrifugal precipitating method of the present embodiment of the invention. FIG. 5B shows a CIE-Y-axial box plot of a pre-precipitated LED and an LED using the centrifugal precipitating method of the present embodiment of the invention.

In FIG. 5A, the vertical axis denotes the color coordinate on the CIE-X-axis, the horizontal axis denotes the data group Dx11 of the axial light intensity of the pre-precipitated LED, the data group Dx12 of the luminous flux measured by an integrating sphere, the data group Dx21 of the axial light intensity of the LED using the centrifugal precipitating method of the present embodiment of the invention, and the data group Dx22 of the luminous flux measured by the integrating sphere. The medians of the data groups Dx11, Dx12, Dx21, and Dx22 are respectively designated by Mx11, Mx12, Mx21, and Mx22. Calculation shows that the medians Mx11 and Mx12 of FIG. 5A are differed by 0.0097, and the medians Mx21, Mx22 are differed by 0.002. As the difference (0.002) between the medians Mx21 and Mx22 is smaller than the difference (0.0097) between the medians Mx11 and Mx12, the CIE-X-axial box plot of FIG. 5A shows that the axial light intensity and the luminous flux of the LED using the centrifugal precipitating method of the present embodiment of the invention are closer to each other than that of the pre-precipitated LED, so that the LED has an even light color distribution when being disposed on the backlight module.

In FIG. 5B, the vertical axis denotes the CIE-Y-axial color coordinate, the horizontal axis denotes the data group Dy11 of the axial light intensity of the pre-precipitated LED, the data group Dy12 of the luminous flux measured by the integrating sphere, the data group Dy21 of the axial light intensity of the LED using the centrifugal precipitating method of the present embodiment of the invention, and the data group Dy22 of the luminous flux measured by the integrating sphere. The medians of the data group Dy11, Dy12, Dy21, and Dy22 are respectively designated by My11, My12, My21, and My22. Calculation shows that the medians My11 and My12 of FIG. 5B are differed by 0.012, and the median My21, My22 are differed by 0.0035. As the difference (0.0035) between the medians My21 and My22 is smaller than the difference (0.012) between the medians My11 and My12, the CIE-Y-axial box plot of FIG. 5B shows that the axial light intensity and the luminous flux of the LED using the centrifugal precipitating method of the present embodiment of the invention are closer to each other than that of the pre-precipitated LED, so that the LED has an even light color distribution when being disposed on the backlight module.

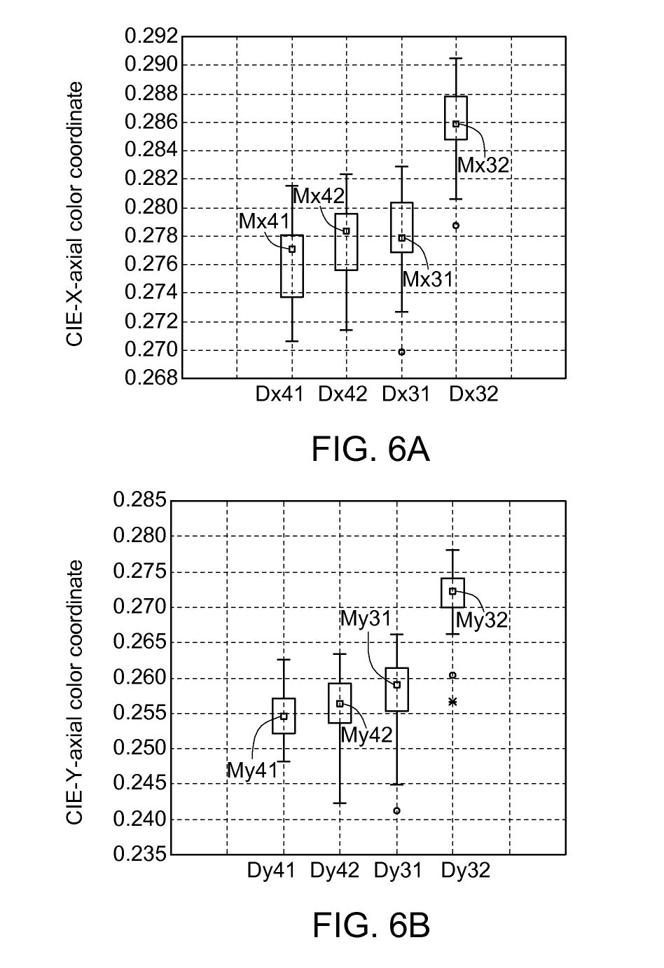

In generally, the white light of the LED is achieved by exciting the materials in the fluorescent particles with the light emitted by the chip. As indicated in FIG. 4, after applying the centrifugal precipitating method of the present embodiment of the invention, the fluorescent particles of the LED can precipitate on the bottom surface of the recess and on the light output surface of the chip. Thus, the light emitted by the chip can be regarded as a white light generated by exciting the materials of the fluorescent particles at one time. Under the same circumstances of exciting the materials of the fluorescent particles at one time, in order to further verify whether the precipitating position of the fluorescent particles is also one of the factors affecting light emitting effect, the description is developed with reference to FIG. 6A. FIG. 6A shows a CIE-X-axial box plot of an anti-precipitated LED and an LED using the centrifugal precipitating method of the present embodiment of the invention. FIG. 6B shows a CIE-Y-axial box plot of an anti-precipitated LED and an LED using the centrifugal precipitating method of the present embodiment of the invention.

In FIG. 6A, the vertical axis denotes the CIE-X-axial color coordinate, the horizontal axis denotes the data group Dx31 of the axial light intensity of the anti-precipitated LED, the data group Dx32 of the luminous flux measured by the integrating sphere, the data group Dx41 of the axial light intensity of the LED using the centrifugal precipitating method of the present embodiment of the invention and the data group Dx42 of the luminous flux measured by the integrating sphere. The medians of the data groups Dx31, Dx32, Dx41 and Dx42 are respectively designated by Mx31, Mx32, Mx41 and Mx42. Calculation shows that the medians Mx31 and Mx32 of FIG. 6A are differed by 0.0097, and the medians Mx41 and Mx42 are differed by 0.002. As the difference (0.002) between the medians Mx41 and Mx42 is smaller than the difference (0.0097) between the medians Mx31 and Mx32, the CIE-X-axial box plot of FIG. 6A shows that the axial light intensity and the luminous flux of the LED using the centrifugal precipitating method of the present embodiment of the invention are closer to each other than that of the anti-precipitated LED, so that the LED has an even light color distribution when being disposed on the backlight module.

In FIG. 6B, the vertical axis denotes the color coordinate of the CIE-Y-axis, the horizontal axis denotes the data group Dy31 of the axial light intensity of the anti-precipitated LED, the data group Dy32 of the luminous flux measured by the integrating sphere, the data group Dy41 of the axial light intensity of the LED using the centrifugal precipitating method of the present embodiment of the invention, and the data group Dy42 of the luminous flux measured by the integrating sphere. The medians of the data groups Dy31, Dy32, Dy41 and Dy42 are respectively designated by My31, My32, My41 and My42. Calculation shows that the medians My31 and My32 of FIG. 6B are differed by 0.008, and the median My41, My42 are differed by 0.0035. As the difference (0.0035) between the medians My41 and My42 is smaller than the difference (0.008) between the median My31 and My32, the CIE-Y-axial box plot of FIG. 6B shows that the axial light intensity and the luminous flux of the LED using the centrifugal precipitating method of the present embodiment of the invention are closer to each other than that of the anti-precipitated LED, so that the LED has an even light color distribution when being disposed on the backlight module.

### Second Embodiment

This embodiment differs with the first embodiment in the design of the cartridge, the heater and the fixing mechanism of a centrifugal precipitating apparatus. Similar or identical components in the embodiment are labeled with similar or identical reference numbers and repetitive descriptions are not repeated here. Besides, the present embodiment of the invention is again taken the pre-precipitated LED 100 of the lighting structure 10 in FIG. 1A as an example for illustration.

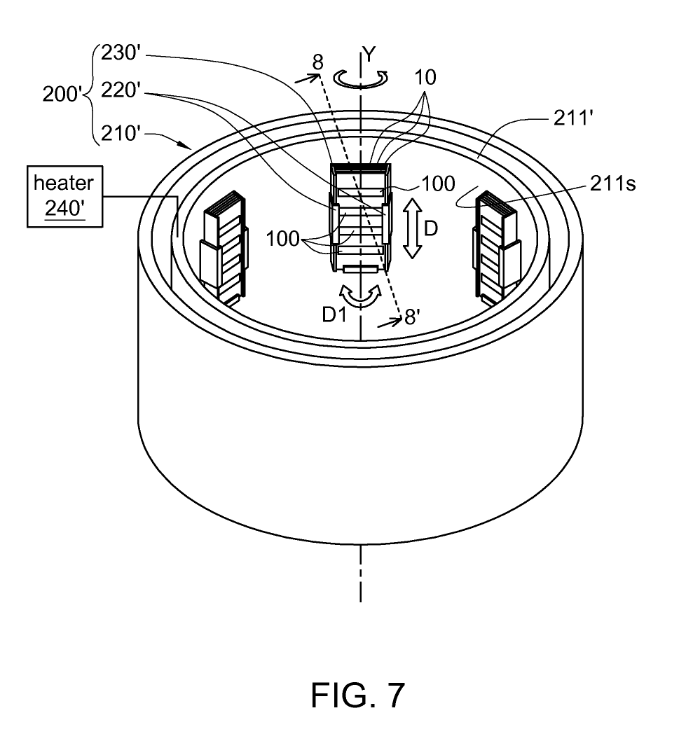

FIG. 7 is a schematic diagram showing the lighting structure of FIG. 1A disposed on the centrifugal precipitating apparatus according to a second embodiment of the invention. As compared with the first embodiment, the centrifugal precipitating apparatus 200′ of the present embodiment of the invention further includes a cartridge 230′ and a heater 240′. The cartridge 230′ and the heater 240′ are disclosed exemplarily below.

The cartridge 230′ is for receiving and fixing several lighting structures 10 as indicated in FIG. 1A, so that the fluorescent particles P (as indicated in FIG. 1B) of the LEDs 100 of the lighting structures 10 can be precipitated. Each lighting structure 10 is fixed in the cartridge 230′ with the colloid 130 facing the rotation axis Y of the accommodation recess 211′, and the lighting structures 10 are stacked with each other. Thus, the fixing mechanism 220′ fixes the lighting structure 10 on an inner wall 211s of the accommodation recess 211′ through the cartridge 230′. It is assumed that the pre-precipitated LEDs 100 of the lighting structure 10 are arranged along a direction D, then the lighting structure 10 is preferably disposed in the cartridge 230′ with the direction D being parallel to the rotation axis Y of the accommodation recess 211′ along the direction D, whereby the centrifugal force can be evenly provided to the pre-precipitated LEDs 100.

The heater 240′ is for increasing the temperature at each lighting structure 10. In the present embodiment of the invention, the temperature at each lighting structure 10 is correspondingly increased as the temperature at the cavity of the accommodation recess 211′ is increased. The glue 131 of the colloid 130 of the present embodiment of the invention can be implemented by a thermosetting material. As such, when the heater 240′ increases the temperature at the cavity of the accommodation recess 211′ and correspondingly increases the temperature at each lighting structure 10, the surface of the glue 131 of each lighting structure 10 is temporarily solidified. Therefore, this embodiment can reduce the likelihood that the colloid 130 filled in the recess 111 may disperse outside when the lighting structure 10 is vertically disposed. The heater 240′ can also be disposed on the inside of the centrifugal precipitating apparatus 200 as indicated in FIG. 2.

According to the present embodiment of the invention, the fixing mechanism 220′ is swingably disposed on the accommodation recess 211′ of the rotation apparatus 210′ for fixing and driving each lighting structure 10 to swing along a first direction D1. Thus, the colloid 130 can be evenly distributed in the recess 111, and can be avoided from being dispersing outside the recess 111 when each lighting structure 10 is vertically disposed. FIG. 8 is a cross-sectional view along the cross-sectional line 8-8′ of FIG. 7. The fixing mechanism 220′ can further drives each lighting structure 10 to swing along a second direction D2, and the fixing mechanism 220′ determines whether to drive each lighting structure 10 to swing along the second direction D2 according to the rotation speed of the accommodation recess 211′ of the rotation apparatus 210′. When the fixing mechanism 220′ drives each lighting structure 10 to swing along the second direction D2, each lighting structure 10 turns from a position with the colloid 130 facing upward (as shown in the position marked by dash lines of FIG. 8) to a position with the colloid 130 facing the rotation axis Y of the accommodation recess 211′ (as shown in the position marked by solid lines of FIG. 8), or vice versa, i.e., it turns from a position with the colloid 130 facing the rotation axis Y of the accommodation recess 211′ to a position with the colloid 130 facing upward.

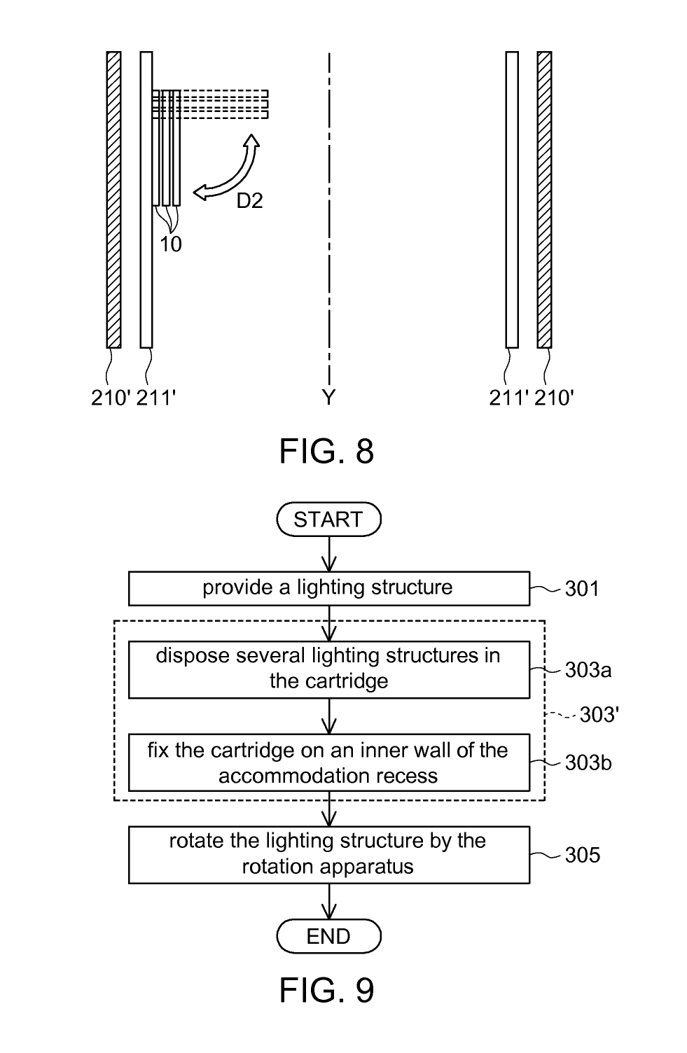

Corresponding to the designs of the cartridge 230′, the heater 240′ and the fixing mechanism 220′ of the centrifugal precipitating apparatus 200′, the centrifugal precipitating method of the present embodiment of the invention includes steps 301, 303′ and 305 as indicated in FIG. 9. Steps 301 and 305 of FIG. 6 are similar to steps 301 and 305 of FIG. 3 and are not repeated here.

The method begins at step 301, several lighting structures 10 as indicated in FIG. 1A are provided.

Next, the method proceeds to step 303′ which includes steps 303a and 303b for fixing the lighting structure 10 on the rotation apparatus 210′. In step 303a, several lighting structures 10 are disposed in the cartridge 230′. Next, in step 303b, the fixing mechanism 220′ is used for fixing the cartridge 230′ on an inner wall 211s of the accommodation recess 211′ of the rotation apparatus 210.

The accommodation recess 211′ of the present embodiment of the invention has, for example, a diameter of 100 cm. In step 305, the accommodation recess 211′ is rotated at, for example, a rotation speed of 1500 rpm, so that the lighting structure 10 is driven to rotate through the fixing mechanism 220′ and the cartridge 230′. As the lighting structure 10 is fixed in the cartridge 230′ with its colloid facing the rotation axis Y of the accommodation recess 211′, the fluorescent particles P of the colloid 130 of each pre-precipitated LED 100 are moved toward the bottom surface 111s of the recess 111 by the centrifugal force generated during rotation, whereby the fluorescent particles P of the colloid 130 are distributed in a manner illustrated in FIG. 4.

In the centrifugal precipitating method of the present embodiment of the invention, the step 305 is further executed by using the heater 240′ to increase the temperature in the cavity of the accommodation recess 211′, so as to heat each lighting structure 10. Thus, the surface of the glue 131 is solidified to avoid the colloid 130 dispersing outside the recess 111. Besides, in step 305, each lighting structure 10 can be driven to swing along a first direction D1 of FIG. 7 or along a second direction D2 of FIG. 8. For example, in step 305, when each lighting structure 10 is driven to rotate by the accommodation recess 211′ of the rotation apparatus 210′ which is rotated, each lighting structure 10 can be driven to swing along the first direction D1 as the fixing mechanism 220′ swings, so that the colloid 130 is evenly distributed in the recess 111 and will not disperse outside the recess 111. Another example will be made by using the swing movement of the fixing mechanism 220′ for driving each lighting structure 10 to swing along the second direction. In the step of swinging, whether to swing each lighting structure 10 is determined according to the rotation speed at which the accommodation recess 211′ rotates to drive each lighting structure 10. Furthermore, each lighting structure 10 can be located at a position marked by dash lines in FIG. 8 when the accommodation recess 211′ just starts to rotate, and each lighting structure 10 swings to a position marked by solid lines in FIG. 8 when the rotation speed of the accommodation recess 211′ reaches a half of the maximum rotation speed. Thus, the colloid 130 can be prevented from being dispersed outside the recess 111.

According to the second embodiment of the invention, more lighting structures 10 can be processed at the same time through the use of a cartridge 230′, hence having the advantage of increasing productivity in addition to the advantages disclosed in the first embodiment. Besides, the disposition of the heater 240′ and the swingable design of the fixing mechanism 220′ can avoid the colloid 130 from being dispersed outside the recess 111.

According to the centrifugal precipitating method and LED and apparatus using the same disclosed in the above embodiments of the invention, a centrifugal force is provided to the lighting structure so that the fluorescent particles of the colloid are moved toward a bottom surface of the recess. Therefore, the fluorescent particles can quickly precipitate on the light output surface of the chip and on the bottom surface of the recess. Besides, the surface of the colloid in the lighting structure is even while the air stored in the colloid is also discharged. Thus, the light emitting effect, conformity rate, and quality of the LED are correspondingly increased. Moreover, with the application of the cartridge, productivity is further increased in an above-mentioned embodiment.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A centrifugal precipitating method, comprising the following steps:
(a) providing a lighting structure, wherein the lighting structure comprises a frame, a chip and a colloid, the frame has a recess, the chip is disposed on a bottom surface of the recess, the colloid comprises a glue and a plurality of fluorescent particles, the glue is filled in the recess and covers the chip, and the fluorescent particles are distributed in the glue; and
(b) rotating the lighting structure for moving the fluorescent particles toward the bottom surface of the recess.

2. The centrifugal precipitating method according to claim 1, wherein the step (b) comprises:
(b1) fixing the lighting structure on a rotation apparatus; and
(b2) rotating the lighting structure by the rotation apparatus.

3. The centrifugal precipitating method according to claim 2, wherein the rotation apparatus has an accommodation recess, the step (b1) comprises fixing the lighting structure on an inner wall of the accommodation recess, and the step (b2) comprises rotating the lighting structure through the rotation of the accommodation recess.

4. The centrifugal precipitating method according to claim 3, wherein the step (b1) comprises fixing the lighting structure on the inner wall with the colloid facing the rotation axis of the accommodation recess.

5. The centrifugal precipitating method according to claim 3, wherein the step (b1) comprises:
(b11) disposing a plurality of lighting structures in a cartridge; and
(b12) fixing the cartridge on the inner wall of the accommodation recess.

6. The centrifugal precipitating method according to claim 5, wherein, in the step (b11), the lighting structures are stacked with each other when being disposed in the cartridge, and each lighting structures is disposed with the colloid facing the rotation axis of the accommodation recess.

7. The centrifugal precipitating method according to claim 1, further comprising:
heating the lighting structure.

8. The centrifugal precipitating method according to claim 1, further comprising:
swinging the lighting structure.

9. The centrifugal precipitating method according to claim 8, wherein in the swinging step, whether to swing the lighting structure is determined according to the rotation speed of the lighting structure.

10. A light emitting diode (LED), comprising:
a frame having a recess;
a chip disposed on a bottom surface of the recess; and
a colloid, comprising:
a glue filled in the recess and covering the chip; and
a plurality of fluorescent particles distributed in the glue by way of covering the bottom surface of the recess and the light output surface of the chip.

11. A centrifugal precipitating apparatus used in a lighting structure, wherein the lighting structure comprises a frame, a chip and a colloid, the frame has a recess, the chip is disposed on a bottom surface of the recess, the colloid comprises a glue and a plurality of fluorescent particles, the glue is filled in the recess and covers the chip, and the fluorescent particles are distributed in the glue, the centrifugal precipitating apparatus comprising:
a rotation apparatus for rotating the lighting structure, so that the fluorescent particles are moved toward the bottom surface of the recess; and
a fixing mechanism disposed on the rotation apparatus for fixing the lighting structure.

12. The centrifugal precipitating apparatus according to claim 11, wherein the rotation apparatus has an accommodation recess, the fixing mechanism is disposed on an inner wall of the accommodation recess, and the accommodation recess is for rotation.

13. The centrifugal precipitating apparatus according to claim 12, wherein the fixing mechanism fixes the lighting structure with the colloid facing the rotation axis of the accommodation recess.

14. The centrifugal precipitating apparatus according to claim 12, further comprising:
a cartridge for receiving and fixing a plurality of lighting structures, wherein the fixing mechanism fixes these lighting structures through the cartridge.

15. The centrifugal precipitating apparatus according to claim 14, wherein the colloid of each lighting structure is fixed in the cartridge by way of facing the rotation axis of the accommodation recess, and the lighting structures are stacked with each other.

16. The centrifugal precipitating apparatus according to claim 11, further comprising:
a heater for heating the lighting structure.

17. The centrifugal precipitating apparatus according to claim 11, wherein the fixing mechanism is swingably disposed on the rotation apparatus for fixing and driving the lighting structure to swing.

18. The centrifugal precipitating apparatus according to claim 17, wherein the fixing mechanism determines whether to drive the lighting structure to swing according to the rotation speed of the rotation apparatus.
